(19) United States
(12) Patent Application Publication
(10) Pub. No.: US 2009/0277081 A1
(43) Pub. Date: Nov. 12, 2009

(54) APPARATUS AND METHOD FOR CULTIVATING A TREE

(76) Inventor: John G. Georges, Arcadia, FL (US)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/401,186

(22) Filed: Mar. 10, 2009

Related U.S. Application Data
(60) Provisional application No. 61/035,207, filed on Mar. 10, 2008.

(51) Int. Cl. A01G 13/02; A01G 25/16; A01G 1/06; A01C 14/00; A01C 15/00

(52) U.S. Cl. 47/6; 47/20.1; 47/21.1; 47/32.3; 111/200; 47/58.1 R; 47/58.1 FV

(57) ABSTRACT

An apparatus and method cultivate trees by preventing freezing and frost damage and inhibiting root stalk sprouts. The apparatus is a frustoconical cover that rests on the ground to cover the root ball of the tree. The stalk and leaves are extended from a hole in the frustum. Water such as mist is injectable within the cover to prevent cold and frost damage.

### CROSS-REFERENCE TO RELATED APPLICATIONS

This application claims the benefit of U.S. Provisional Application No. 61/035,207, filed Mar. 10, 2008.

### BACKGROUND OF THE INVENTION

1. Field of the Invention

The invention relates to apparatuses and methods for cultivating trees, in particular, grafted fruit trees.

2. Description of the Related Art

To combine the qualities of different trees, portions of different trees can be grafted together. In the case of fruit trees, especially orange trees, orange stalks can be grafted to native stalks. Native stalks are more disease resistant than stalks that provide the best fruit. However, native stalks produce sour juicy fruit. To produce the best combination, the lower stalk of a native tree including the root ball is grafted to the upper stalk of a fruit bearing tree. Typically, the graft is made on the stalk about twenty centimeters (˜20 cm) above the ground.

When trees are pruned significantly, the tree may produce auxins. Auxins trigger growth in the tree. In this way, when a root ball is pruned (i.e. for grafting), auxins are produced. Auxins can cause sprouts to sprout from the stalk connected to the root ball (i.e. native, sour-producing stock). The sprouts are based on the root ball stock, which does not bear fruit, and rob nutrients from the fruit tree stalk. Sprouts can even outgrow and strangle the grafted stalk. Accordingly, a need exists to inhibit the growth of sprouts from the root ball of grafted trees.

FIG. 6 shows grafted tree 100. The tree 100 includes a root ball 101. A stalk 102 is grafted to the root stalk 101 along the graft 103. Sprouts 104 extend upward from the root stalk 102. Leaves 106 sprout from the top of the stalk 105.

Another problem with fruit-tree cultivation is freezing and frosts. When the ambient temperature falls below the freezing point or the frost point, the leaves and fruits of the tree can become damaged. Irrigation systems can be used to water the trees during such times. The heat provided by watering is quickly dissipated from the trees, especially on windy nights. The cold air blowing on the wet tree can freeze the water on the tree. Ice formation can damage and defoliate a tree. Defoliated trees can take one to two months before they become productive again.

Natural grasses surrounding trees can strangle the trees. Natural grasses grow quickly and can be several feet high. The natural grasses can be taller than the young trees. Herbicides are used to inhibit wild grasses. However, the herbicide must be hand sprayed, which is very labor intensive. Mechanical spraying methods do not work because they result in the cultivated tree being sprayed. The herbicides can kill the cultivated tree. The herbicides may be toxic to people as well. Therefore, the herbicides should not contact the tree including the root ball.

The prior art falls into two categories. The first are flower pots. Flower pots are vessels that hold a plant and surrounding soil. Flower vessels do not define airspaces between the wall of the vessel and the plant and do not work to inhibit unwanted sprouts stemming from the root ball. The second category of prior art is transparent vessels that are terrariums. The terrariums do not inhibit the growth of root ball sprouts within the terrarium.

U.S. Pat. No. 726,766 discloses a, “Flower Pot.” A conical flower-pot increases in diameter from top to bottom, the conical wall of which is made in halves provided on the joints with a plurality of inwardly-inclined tongues and grooves for engaging each other and preventing any dislocation of said halves, the one of said halves being made in One Piece with the bottom. The conical wall is provided with a plurality of ventilating and evaporating holes placed more or less vertically.

U.S. Pat. No. 1,534,508 discloses an, “Apparatus for Testing Soil or Seed.” This patent teaches a container in which soil may be placed and seed grown under conditions such that the soil in the container is exposed only to a minimum degree to the effect of the external atmosphere, while at the same time conditions for growth of seed in the container during a test are controlled.

U.S. Pat. No. 2,550,602 is titled, “Potted Plant Container.” The patent shows a container that is shaped like an inverted hollow cone having its larger portion at the bottom. This bottom portion is closed by a bottom surface and is formed with a central upwardly projecting nipple. The container is adapted to rest in a lower bowl portion. The bowl has a larger circumference than the bottom portion of the container.

U.S. Pat. No. 3,785,088 is titled, “Nursery Pot.” The nursery pot has a first series of vertically and circumferentially spaced, relatively large openings in the side wall of the pot, and a second series of openings at the juncture of the side wall and the bottom of the pot. Both series of openings permit drainage of excess moisture from and entry of ambient air into the pot to promote root growth, with the second series of openings being bounded by inwardly directed flanges for the purpose of directing root growth in the vicinity of the second series of openings inwardly toward the center of the pot rather than outwardly through the bottom openings.

U.S. Pat. No. 3,991,516 is titled, “Separating Flower Pot.” The segmented container for potted plants and shrubs of the type define an inverted conical shape or spherical zone segment which provides greater volume of earth at the base of the container than at the top to encourage greater and healthier root growth. The container assembly has a base and two or more separable upper segments which are removeable to enable plant withdrawal with minimal damage to the root system or foliage. When assembled, the container provides a leak proof, structurally functioning container capable of rapid assembly and disassembly.

U.S. Pat. No. 5,398,443 is titled, “Windowed Shelter For Plants.” The shelter protects young plants and has a shell (10) made from a translucent resin material. Windows (28) are formed through a peripheral wall (16) on one side of the shell (10) for controlling the admission of light and air into the shelter. A hood (30) made from a transparent film of resin material covers the windows (28) to conserve heat and moisture within the shelter. The young plants are acclimated to their surroundings by progressively removing the hood (30) from the windows (28).

U.S. Pat. No. 6,038,810 is titled, “Plant Enclosure For Outdoor Use.” The plant enclosure for outdoor use has a hollow body with open upper and lower ends and ventilation and drainage openings. In order to permit a desired amount of water to be conserved within the base of the enclosure, the openings are positioned such that a portion of the body may be buried in the soil, with the openings spaced above the soil surface. The base of the body has plant root openings, positioned to be buried beneath the soil surface. These openings are sized to permit plant roots to grow laterally outwardly close to the soil surface, beyond the perimeter of the enclosure. A lid is engageable to the upper rim of the body. The lid has a recessed portion on its upper surface to capture rain or sprinkler water. Apertures within the lid permit the captured water to drain into the enclosure. Preferably, the body and lid are clear or translucent to create a greenhouse effect during daylight hours.

U.S. Pat. No. 6,357,180 is titled, “Push-Pull Root Air-Pruning Tray and Container Systems.” The systems entail a plant/seedling/cutting/plug growing tray and container system that includes a tray with a plurality of individual plant cells and container with each cell and container having an open top and bottom and a detachable screen bottom, and that allows plant removal either from the open bottom of the tray/container or open top of the tray/container. As plant roots emerge through an open-bottom tray or container supported above ground, the roots shrivel due to contacting dry air and temporarily suspend their growth. This bare-root growth phenomenon is known as air pruning. Proper application of root air-pruning process in conjunction with the use of properly shaped tray-cells and containers (small at the top and gradually getting larger at the bottom) significantly increases plant production, improves crop quality and promotes mechanization. Air pruning alone without the right tray and container will not provide these benefits. The system, which utilizes computer optimization techniques to determine the proper inner sidewall angle of tray-cells and containers, also allows air-pruned plants to be manually or automatically removed from the open tops of tray-cells and containers. Alternatively, in one embodiment, the plant container consists of more than one piece of sidewalls which can be put together to form a plant container. In addition, the detachable screen is provided with a series of projecting legs designed for self-supporting so as to detachably secure the screen into the plant tray and container structure to facilitate root air pruning.

Japanese Publication JP2002191234A is titled, “Culturing Container.” The culturing container provides a culturing container capable of activating growing state of a plant and simplifies operation for harvesting potatoes, root vegetables, etc., reducing load of transportation, assembly and removal operation when using as a member for planting device installed at high position. To do this, the culturing container 10 is obtained by forming a film 12 made of a synthetic resin into a downwardly widened bag body having an opening 13 at the upper end and having the bottom 14 at the lower end. Because an inner diameter (r) of the opening 13 in expansion is smaller than minimum inner diameter R of the bottom 14, when culture soil 16 is packed, the culturing container 10 becomes nearly circular truncated cone-like shape and culture of plants can be carried out on a culture soil part exposed to the opening 13.

Japanese Patent Application No. JP2003116358A is titled, “Cultivation Container Made From Ceramics And Method For Producing The Same.” The container provides a cultivation container made from a ceramic capable of inhibiting the occurrence of root rot, because the adjustment of water content in the cultivation container is extremely good, having a high dealing capacity with an atmospheric temperature change so as to be able to prevent the temperature of the cultivation container from elevating extraordinarily; excellent in water permeability and air ventilating property, not especially being required to form a water-discharging port and capable of prohibiting the invasion of noxious insects, and a method for producing the same container. This cultivation container 1 has a bottom wall part 2 and a side wall part 3, which is provided by forming multiple fine holes 4 through which the inside of the container communicates with outside on the bottom wall part 2 or the side wall part 4 and constituting so that water or air can pass through the fine holes 4. Therefore, the container is excellent in water permeability and air ventilating property and also not especially required to form the water-discharging port on the bottom wall part since many fine holes act as the discharging ports, and can prohibits the invasion of the noxious insects.

Japanese Patent Publication No. JP2003310062A is titled, “Planting Vessel.” The vessel provides a planting vessel effective for preventing the spill of the content in distribution and the damage of an ornamental plant planted in the vessel. A particle layer 36 composed of a number of mutually bonded particles 22 is placed to close a second opening 20 of the planting vessel 10. Horticultural soil 38 for the growth of the root 30 of the ornamental plant 16 is held in the vessel without spillage by using the vessel 10 directing the 2nd opening 20 downward. The particle layer 36 contains interconnected pores 26 to keep high air permeability and draining property. The vessel is provided with a 1st opening 18 for planting the plant 16, and the spillage of the soil 38 from the opening 18 is prevented by selecting the opening size as small as possible to a level not to cause the adverse effect on the growth of the ornamental plant 16.

### BRIEF SUMMARY OF THE INVENTION

It is accordingly an object of the invention to provide an apparatus and a method of using the apparatus that overcomes the above-mentioned disadvantages of the heretofore-known devices and methods of this general type.

An object of the invention is to provide an apparatus and method that inhibit sprouts from a root stalk.

A further object of the invention is to provide an apparatus and a method that mitigates loss of heat provided by misting systems.

A further object of the invention is to provide an apparatus and a method that allow mechanical herbicide spraying around trees of a herbicide that should not contact the tree.

In accordance with the objects of the invention, an apparatus is provided for protecting a sprouted tree with a root ball and a stalk and for inhibiting root stalk sprouts. The apparatus includes an opaque frustoconical cover. The cover has a base and a frustum with a hole formed in the frustum. The base is wider than the root ball and the hole is wider than the stalk. The cover defines an airspace in which water can be injected, sprayed, or misted. The injected water warms and irrigates the tree contained within the container.

The base of the cover can include outwardly extended member such as an annular rim, a flange, or lateral member. The outwardly extended member can be buried with soil to hold the cover on the ground. The soil should provide enough weight to hold the cover over the tree during wind. The soil should hold the cover on tree when sprouts press upward, against the cover from within the cover.

In accordance with the objects of the invention, a water supply can be inserted within the cover. The water supply is typically an irrigation system. A mist generating outlet such a micro system can be attached to the water supply pipe within the cover to generate a mist. Micro system is a term of art and includes means for generating a mist such as micro jets and micro drips. An additional or separate water pipe for irrigation can be inserted within the cover for irrigating the tree. The pipe connected to the mist-generating outlet can be used to irrigate the tree as well as to generate mist within the cover.

In accordance with the objects of the invention, a ventilation passage can be provided on or formed by the cover. The ventilation passage allows air to be exchanged through the cover but prevents light from entering the cover. The ventilation passage prevents fungi from growing within the cover. The ventilation passage can have a tortuous passage (i.e. not a direct line) to allow air to enter but to prevent light from entering the cover.

In accordance with a further object of the invention, a seam can be formed in the wall of the cover reaching from the base to the frustum. The seam allows the cover to be removed without pulling the cover over the tree. The stalk of the tree can be slid through the seam.

The cover can be made of flexible, resilient polymer material, like a plastic garbage can. The cover can be made by molding.

In accordance with the objects of the invention, a method of cultivating a sprouted tree with a root ball, a stalk sprouting from the root ball, and a leaf sprouting from the stalk is encompassed within the invention. The first step of the method is enclosing at least a portion of the stalk with an opaque cover while exposing the leaf. The opaque cover has a base contacting ground above the root ball. The opaque cover encircles the root ball to keep it warm, to discourage sprouts from the root ball, and to protect the root ball from outside contaminates such as herbicides. The next step of the method is maintaining airspace between the opaque cover, the stalk, and the ground.

In accordance with the objects of the invention, the method includes injecting water into the airspace to warm the tree. Water, in particular water mist, can be injected within the cover to prevent the tree from freezing. The cover decreases the amount of water necessary because the cover prevents evaporation. In addition, the cover acts and enclosed airspace act as an insulating layer. The timing of the injection can be based on the temperature outside cover. For example, once the outside temperature reaches a specific temperature, such as the freezing point, water can be injected into the cover. Alternatively, the temperature within the cover can be used as the threshold below which water is injected into the cover.

In an experiment where covered and uncovered trees were misted with an ambient temperature below freezing (0° C.), temperatures within the cover of the apparatus were measured to be three to four degrees Celsius warmer than uncovered trees. This difference is critical in climates like central and northern Florida that have minimum annual temperatures of minus three degrees centigrade (−3° C.).

In accordance with the objects of the invention, solid fertilizer can be added within the cover. The solid fertilizer can release nutrients to the soil over time.

A herbicide can be sprayed around the opaque cover. In particular, the herbicide can be applied with mechanical means, as contrasted to applying by hand. Herbicide is used to eliminate wild grasses from growing taller than the tree. The wild glasses surrounding the tree will “strangle” the tree. The herbicides may kill the tree itself or make the tree toxic. The cover prevents the herbicide from reaching the root ball and contaminating the tree.

Other features which are considered as characteristic for the invention are set forth in the appended claims.

Although the invention is illustrated and described herein as embodied in an apparatus and method for cultivating a sprouted tree, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic front side view of a cover according to the invention.

FIG. 2 is a left side view of the cover.

FIG. 3 is a top side view of the cover.

FIG. 4 is a bottom side view of the cover.

FIG. 5 is a top left perspective view of the cover.

FIG. 6 is a left side sectional view of the cover shown with the tree, watering system, and surrounding environment taken along line VI-VI in FIG. 3.

FIG. 7 is a right side view of the cover shown vents.

FIG. 8 is a bottom side section view taken along line VIII-VIII in FIG. 7.

### DETAILED DESCRIPTION OF THE INVENTION

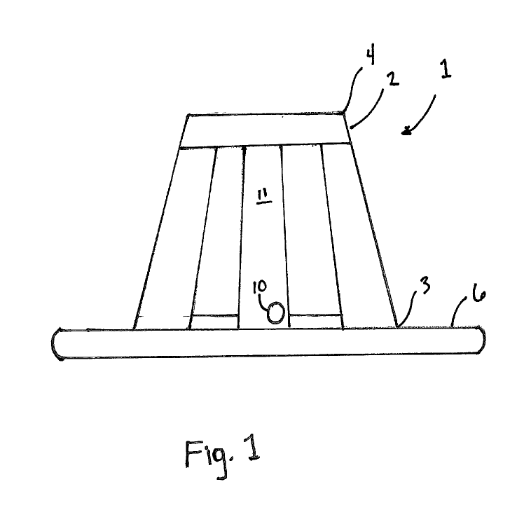

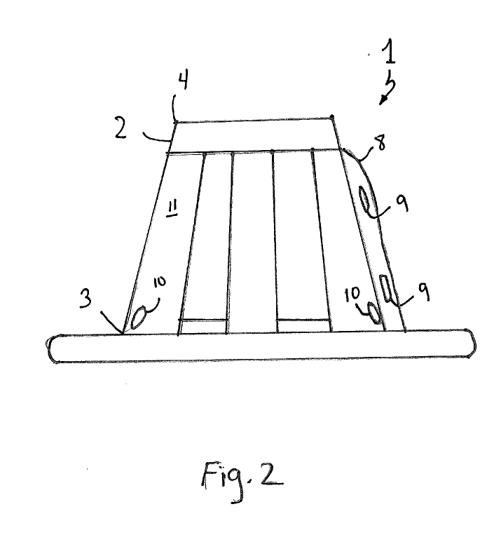

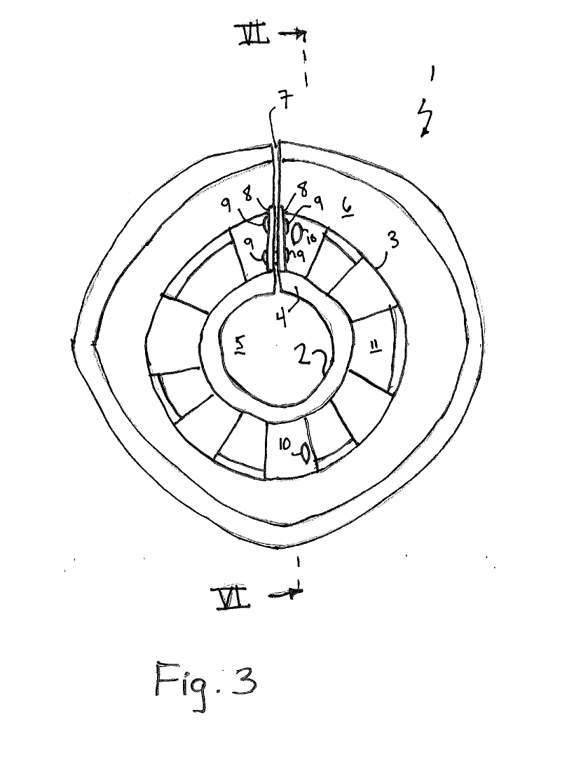

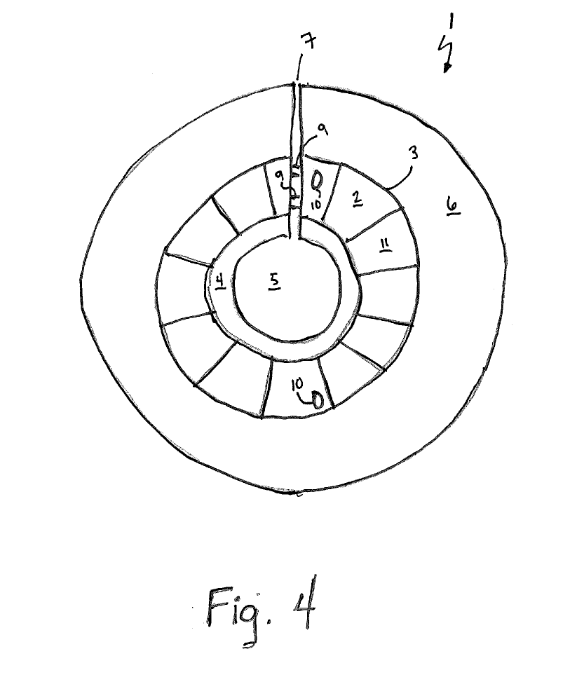

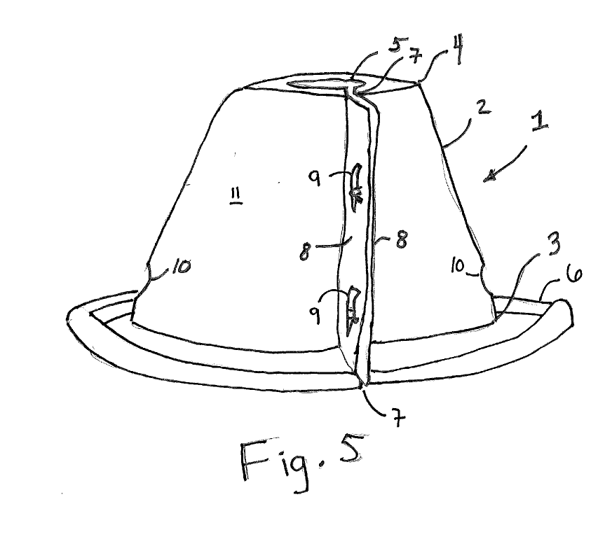

Referring now to the figures of the drawing in detail and first, particularly, to FIGS. 1-5 thereof, there is seen an apparatus 1 for protecting a sprouted tree 100. The apparatus 1 includes an opaque frustoconical cover 2. The frustoconical cover 2 has a base 3 and a frustum 4. A wall 11 extends between the base 3 and the frustum 4. A hole 5 is formed in the frustum 4 through which the leaves 106 of the tree 100 can be exposed.

The cover 2 is made of opaque material such as a flexible resilient polymer. The cover 2 is opaque to light and liquid. By blocking light, the growth of weeds and sprouts, especially from the root stalk 102, is deterred beneath the cover 2. By being impervious to liquids, herbicides can be mechanically sprayed to the surrounding environment and prevented from reaching the root ball underlying the cover 2. The cover 2 is manufactured by molding. Holes 10 and seams 7 can be formed or cut into the cover 2 as desired.

The base 3 of the cover 2 is wider (or at least as wide as) than the underlying root ball 101. By being wider than the root ball 101, herbicides are prevented from reaching the root ball 101. In addition, sprouts from the root ball 101 are caught within the cover 2.

The cover 2 has a height that covers at least fifty percent (≧50%) of the height of the stalk 105 when the cover 2 is being attached; the percentage will decrease as the tree 100 grows. More preferably, the height of the cover 2 is such that it covers sixty to sixty-five percent (60-65%) of the height of the stalk 105 at the time of attaching the cover 2. The height of the cover 2 should not be so high as to cover leaves 106 at the top of the stalk 105. By remaining uncovered, the leaves 106 are able to receive sunlight to sustain the tree 100 when the cover 2 is installed. In the case of orange trees, the height of the cover is approximately sixty centimeters (˜60 cm).

A hole 5 is formed in the frustum 4. The width of the hole 5 should be wider than a width of the stalk 105. By being wider than the stalk 105, the hole 5 allows the stalk 105 to grow. The hole 5 should not be so wide as to allow enough sunlight to reach the ground 200 that weeds and sprouts 104 can thrive.

An annular rim 6 extending from and encircles the base 3. The rim 6 can be buried with sand or soil 201. By burying the rim 6 with soil 201, the cover 2 is held against the ground 200.

A seam 7 runs vertically in the cover 2 from the base 3 to the frustum 4. Because the cover 2 is made of a flexible resilient material, the cover 2 can be spread along the seam 7 to allow the cover 2 to be installed or removed from the tree 100 by sliding the stalk 105 through the seam 7. With the seam 7, the cover 2 does not need to be pulled over the leaves 106 to be removed. The seam 7 has a flange 8 attached along each side of the seam 7 reaching from said base 3 to said frustum 4. A fastener 9 such as a staple or zip connector connects the flanges 8.

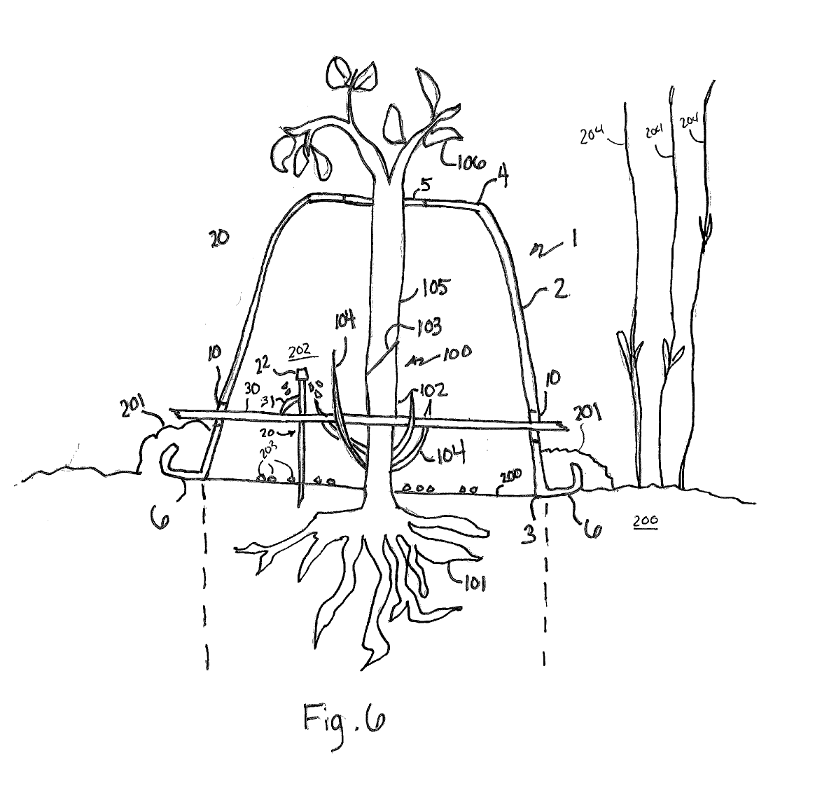

FIG. 6 shows the apparatus 1 connected to a means for watering the tree 100. The means for watering the tree includes a pipe 30. The pipe 30 runs through the cover 2 and enters and exits at holes 10 in the cover 2. The pipe 30 is soft, puncturable polypropylene. A microsystem 20 is staked within the cover 2. A lead 31 is inserted in the pipe 30. The lead is connected to the micro jet 22. The micro spray jet 22 forms a water mist when water is supplied thereto. The micro spray jet 22 can be used to irrigate the tree 100. The micro spray jet 22 sprays water to warm the tree 100 when temperatures fall below a temperature set by the farmer. Possible temperatures for activating the micro spray jet 22 are the freezing point (i.e. zero degrees centigrade) or the frost point. Spraying water within the cover 2 tends to warm the tree 100. Holding the water within the cover 200 increases the warming effect and decreases dissipation of the heat from the water compared to spraying without the cover 2. The invention contemplates that other known systems for watering can be used instead of or in addition to pipe 30 and micro spray jet 22.

In the preferred embodiment, the tree 100 being protected is an orange tree. Orange trees are usually grown in temperate areas, for example, Florida, United States. Ground water in Florida maintains a constant temperature around twenty-two degrees Celsius (22° C.). Significant warming is provided to prevent freezing and frost damage by spraying the trees with ground water.

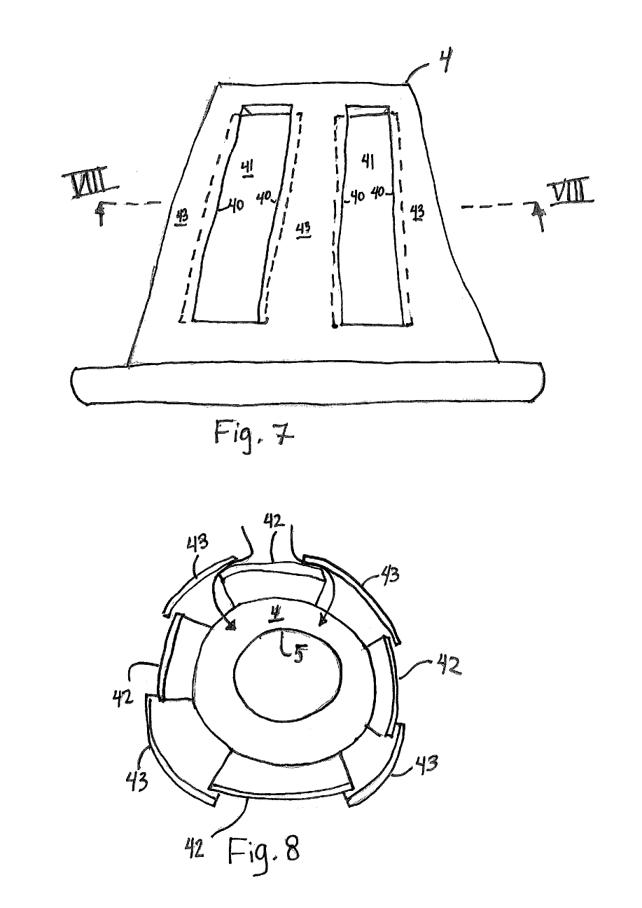

FIGS. 7-8 show an embodiment including air passages formed in the cover. Air passages can be formed in the cover 2. Air passages allow fresh air to enter the cover. While heat can be lost through air vents, the loss is outweighed by preventing fungus growth. A tortured (i.e. non-linear air passage) can be provided by overlapping an inner panel 41 with a raised panel 42. The tortured passages 40 allow air to enter but prevent sunlight from reaching the interior of the cover 6.

FIG. 6 shows a preferred embodiment of the apparatus 1 in use. The tree 100 is formed by grafting a native root ball 101 to an orange tree stalk 105. The stalk 105 is sprouting leaves 106 at the top of the stalk 105. The root ball 101 is planted in the ground 200. Once the tree 100 has been planted, the cover 2 is installed. The cover 2 is installed by lowering the cover 2 over the tree 100. As the opaque cover 2 is lowered, the leaves 106 are pulled through the hole 5 in the frustum 4. The base 3 is rested on the ground 200. The cover 2 is not filled in with soil; an airspace 202 is maintained within the cover 2, between the cover 2, stalk 105, and the ground 200. To secure the cover 2 to the ground 200, soil 201 is added to cover the rim 6.

When installed, the opaque cover 2 prevents sunlight from reaching the ground 200 within the cover 2. If sprouts 104 grow from the root stalk 102, the lack of light, prevents the sprouts 104 from flourishing. As a result, the sprouts 104 will wither and the amount of nutrients stolen from the tree 100 are minimized.

Once installed and secured, the cover 2 is also used to warm the tree 100. When the temperature outside the cover 2 falls below a user-selected temperature such as the frost point or the freezing part, water is injected within the cover. Injected water warms the tree 100 and the airspace 202 within the cover 2. For warming purposes, the water is preferably injected as a mist. The mist is produced by flowing water through the micro spray jet 22. The cover 2 holds the warm mist within the airspace 202 and holds the heat within the cover and prevents dissipation of the heat. In addition, the cover 2 creates an insulative airspace 202 between the outside air and the tree 100.

Solid fertilizer 203 such as time-released fertilizer can be placed on the ground 200 beneath the cover 2. Because the amount of moisture within the cover 2 is controlled through by controlling the irrigation, the time for adding additional fertilizer can be more accurately estimated.

Once the cover 2 is installed, herbicide can be mechanically sprayed on the ground 200 outside the cover 2. The cover 2 prevents the herbicide from reaching the root ball 101. The herbicide is used to kill the grass 204 that can grow taller than the tree 100 and strangle the tree 100.

Once the tree 100 has grown to a sufficient height that it can survive without protection from the cover 2, the cover 2 is removed. To remove the cover 2, the fasteners 9 are cut or otherwise removed. The seam 7 is spread. Next, the stalk 105 is passed through the open seam 7. The cover 2 can be recycled and used a different plant.

While various descriptions of the present invention are described above, it should be understood that the various features can be used singly or in any combination thereof. Therefore, this invention is not to be limited to only the specifically preferred embodiments depicted herein. Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention.

I claim:

1. An apparatus for protecting a sprouted tree with a root ball and a stalk and for inhibiting root ball sprouts, comprising an opaque frustoconical cover having a base and a frustum with a hole formed in said frustum, said base being wider than the root ball and the hole being wider than the stalk.

2. The apparatus according to claim 1, wherein said base has an outward extending annular rim extending from said rim.

3. The apparatus according to claim 1, further comprising a water outlet connected to said cover for spraying water within said cover.

4. The apparatus according to claim 3, wherein said water outlet is a micro spay jet.

5. The apparatus according to claim 1, wherein said frustoconical cover has a wall between said base and said frustum, said wall having a hole formed therein for receiving an irrigation pipe.

6. The apparatus according to claim 5, further comprising an irrigation pipe inserted into said cover, said irrigation pipe being configured to release water to the sprouted tree.

7. The apparatus according to claim 1, wherein said frustoconical cover has a ventilation passage formed therein for ventilating said frustoconical cover.

8. The apparatus according to claim 7, wherein said ventilation passage has a tortuous path allowing air to enter said frustoconical cover while blocking sunlight from directly reaching the stalk.

9. The apparatus according to claim 1, wherein said frustoconical is tall enough to cover at least half of the height of the stalk of the sprouted tree when initially placed.

10. The apparatus according to claim 1, wherein said frustoconical cover has a seam reaching from said base to said frustum.

11. A method of cultivating a sprouted tree with a root ball, a stalk sprouting from the root ball, and a leaf sprouting from the stalk, which comprises:
enclosing at least a portion of the stalk with an opaque cover while exposing the leaf, said opaque cover having a base contacting ground above the root ball and said opaque cover encircling the root ball; and
maintaining an airspace between said opaque cover, the stalk, and the ground.

12. The method according to claim 11, which further comprises:
providing a root ball;
grafting the stalk to the root ball to form the sprouted tree; and
planting the sprouted tree before enclosing the stalk with said opaque cover.

13. The method according to claim 11, which further comprises covering a rim extending from said base with dirt to secure said opaque cover to the ground.

14. The method according to claim 11, which further comprises injecting water into the airspace.

15. The method according to claim 14, which further comprises injecting the water into the airspace when temperature outside the opaque cover falls below a selected temperature.

16. The method according to claim 14, wherein the injecting of the water involves forming a mist.

17. The method according to claim 11, which further comprises adding a solid fertilizer within said opaque cover.

18. The method according to claim 11, which further comprises spraying a herbicide around said opaque cover.

19. The method according to claim 11, which further comprises covering at least fifty percent of a height the stalk when initially enclosing the stalk.

20. The method according to claim 11, which further comprises:
forming a seam in said opaque cover; and
removing said cover by slipping the stalk through said seam.
